(19) United States
(12) Patent Application Publication
(10) Pub. No.: US 2013/0040024 A1
(43) Pub. Date: Feb. 14, 2013

(54) Fruit Products, Methods of Producing Fruit Products, Fruit Extraction Systems and Fruit Infusion Systems

(71) Applicants: Leroy W. Fletcher, Parker, CO (US); Tamis L. Root, Vancouver, WA (US)

(72) Inventors: Leroy W. Fletcher, Parker, CO (US); Tamis L. Root, Vancouver, WA (US)

(21) Appl. No.: 13/208,183

(22) Filed: Aug. 11, 2011

(51) Int. Cl. A23L 1/212

(52) U.S. Cl. 426/281; 426/431; 426/615; 99/495; 99/472; 99/516

(57) ABSTRACT

A method for producing fruit products. The method includes presenting a fruit comprising at least one water insoluble component and at least one water soluble component. Removing at least a portion of the at least one water soluble component from the fruit, the removing comprising leaving at least a portion of the at least one water insoluble component. Providing at least one polyol in the at least a portion of the at least one water insoluble component.

### TECHNICAL FIELD

The invention pertains to fruit products, methods of producing fruit products, fruit extraction systems and fruit infusion systems.

### BACKGROUND OF THE INVENTION

A wealth of information is continually disseminated to the public regarding how society's dietary intake and habits are unhealthy. One exemplary leading cause of problems in dietary health, according to the experts, is the consumption of sugars in the diet. In culinary terms, “sugar” delivers a primary taste sensation of sweetness which is highly desirable. Accordingly, sugar is routinely added or included in the processing of a majority of foodstuff to enhance the enjoyment of the food. For example, a twelve (12) ounce container of regular soda alone may contain 39 grams of added sugar.

However, sugar intake, particularly the large sugar intake of the United States, is associated with several health problems. One exemplary health problem is the result of high blood sugar levels which cause diabetics and weight problems. In response to the health problems of sugar intake, there is a continuing effort to provide a greater variety of foods and beverages having a low or no sugar content and yet provide the sweetness that is highly desirable. That is, there is a need to provide foodstuff that can be characterized as no sugar, low sugar and/or reduced sugar while maintaining sensory characteristics, quality attributes and beneficial attributes of the foods and beverages.

### SUMMARY OF THE INVENTION

A method for producing fruit products. The method includes presenting a fruit comprising at least one insoluble component and at least one soluble component. Removing at least a portion of the at least one soluble component from the fruit, the removing comprising leaving at least a portion of the at least one insoluble component. Providing at least one polyol in the at least a portion of the at least one insoluble component.

### BRIEF DESCRIPTION OF THE DRAWINGS

Preferred embodiments of the invention are described below with reference to the following accompanying drawings.

FIG. 1 illustrates an exemplary fruit processing method for producing fruit product(s) in accordance with one of various aspects of the invention.

FIG. 2 illustrates an exemplary fruit processing method for producing fruit product(s) in accordance with another one of various aspects of the invention.

FIG. 3 illustrates a schematic diagram of an exemplary extraction system in accordance with one of various aspects of the invention.

FIG. 4 illustrates an extraction method using the extraction system of FIG. 3 in accordance with one of various aspects of the invention.

FIG. 5 illustrates a schematic diagram of an exemplary infusion system in accordance with one of various aspects of the invention.

### DETAILED DESCRIPTION OF THE INVENTION

This disclosure of the invention is submitted in furtherance of the constitutional purposes of the U.S. Patent Laws “to promote the progress of science and useful arts” (Article 1, Section 8).

The following various exemplary embodiments of the invention are directed to discussions and descriptions of various fruits and fruit products, and various methods of processing fruits and fruit products. It should be understood that, while the description is directed to fruits and fruit products, various embodiments of the invention are applicable to other foodstuffs not including fruits and fruit products. Exemplary fruits include cranberries, cherries, strawberries, raspberries, blueberries, grapes, apples, peaches, pears, blackberries and any melons (watermelon, cantaloupe, etc.) that can be processed by the inventive methods disclosed herein. However, this is not an exhaustive list and other fruits and foodstuffs are appropriate for application of the inventions described herein.

An exemplary one of various embodiments of the invention is directed to a method of producing or forming one or more fruit product(s) from fruit(s). One exemplary embodiment of the inventive fruit product(s) is a fruit product having at least a reduced sugar content relative to an original fruit provided for processing. And yet, the fruit product will have at least a substantial portion of the desirable sweetness attribute of the original fruit.

It should be understood that while there are other processing alternatives for providing fruit products having reduced sugar content, such alternative processing have their own problems such as providing sweetness characteristics that can be less than desirable. In fact, conventional processing of fruits to form fruit products provide additives to the fruit products, routinely sweeteners, and mainly sugars, to maintain or regain the sweetness characteristics of the original fruit. However, as stated previously, the amount of sugar intake currently occurring in an average person's daily diet is unhealthy.

To facilitate the subsequent discussion of the various inventions, it should be understood that fruits comprise water soluble substances or components (think fruit liquids and/or liquid components including fruit sugars and organic compounds such as acids, ketones, alcohols, etc.) and water insoluble substances (think fruit solids and/or solid components).

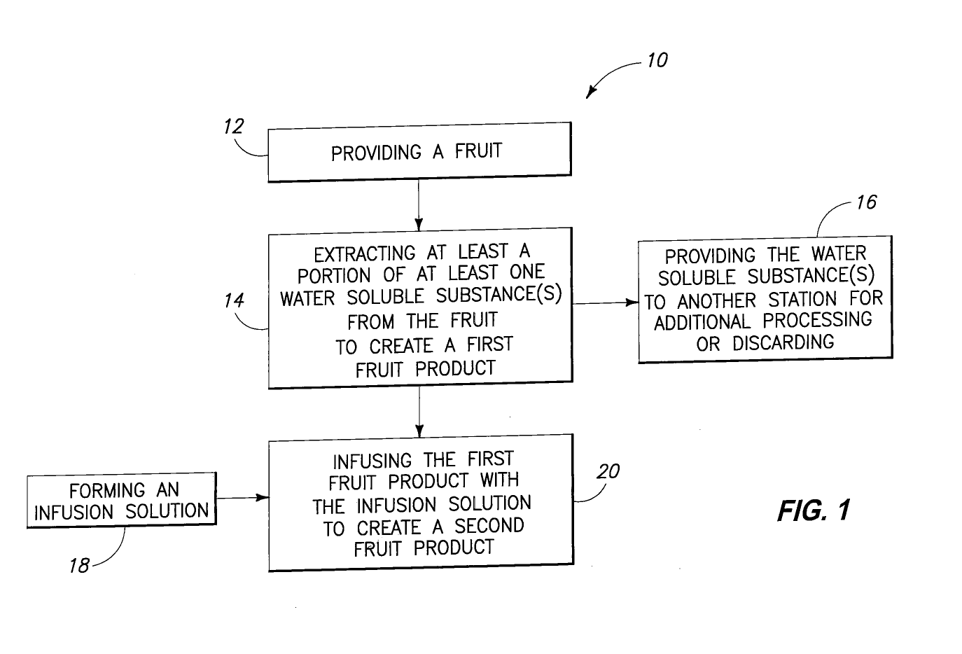

Referring to FIG. 1, an exemplary embodiment of the invention representing an inventive fruit processing method 10 for producing one or more inventive fruit product(s) is described and illustrated. An exemplary first method step 12 includes providing a fruit. An exemplary fruit includes a berry and an exemplary berry includes a cranberry. A more thorough description of implementing the first method step 12 to provide a fruit according to one embodiment of the invention is described subsequently.

Still referring to FIG. 1, an exemplary second method step 14 of fruit processing method 10 includes extracting or removing at least a portion of at least one water soluble substance from the fruit (an exemplary second method step 14 can also be referred to as an exemplary extraction procedure or extraction method step). A more thorough description of inventive apparatuses and methods to implement the second method step to extract water soluble substance(s) from a fruit according to embodiments of the invention are described subsequently.

Still referring to FIG. 1, it should be understood that a portion of only one water soluble substance may be extracted from the fruit during performance of the second method step 14. Alternatively, it should be understood that an exemplary second method step 14 includes removing an entirety of only one water soluble substance from the fruit. Still further, it should be understood that the second method step 14 includes removing more than one water soluble substance from the fruit. Moreover, if more than one water soluble substance is extracted, it should be understood that an exemplary second method step 14 includes removing only a portion of each one water soluble substance from the fruit. Alternatively, if more than one water soluble substance is extracted, it should be understood that the second method step 14 includes removing an entirety of each one water soluble substance from the fruit. Further still, if more than one water soluble substance is extracted, it should be understood that an exemplary second method step 14 includes removing an entirety of one water soluble substance from the fruit while removing only a portion of another water soluble substance from the fruit. That is, if more than one water soluble substance is extracted, it should be understood that the second method step 14 includes removing any combination of: only a portion of any one water soluble substance along with an entirety of any one other water soluble substance.

Still referring to FIG. 1, it should be understood that the removal of the water soluble substance during an exemplary second method step 14 can additionally extract or remove substances from the fruit that are not classified as water soluble, such as water insoluble substances. Exemplary water insoluble substances include solids and solid components such as external cellular coverings or structures such as skins or husks of a berry or fruit, and further include fleshy tissue, pulpy tissue, other internal cell wall tissue and hulls.

It should be understood that exemplary second method step 14 include a portion of only one water insoluble substance to be extracted from the fruit; for example, the portion being less than 90% of the one water insoluble substance removed (and includes less than 89% removed, and less than 88% removed, and less than any increment of 1% removed down to zero). Alternatively, it should be understood that an exemplary second method step 14 includes removing substantially an entirety of only one water insoluble substance from the fruit; for example, 90% and greater of the one water insoluble substance and includes a range of 90% to 97% removed. Still further, it should be understood that the second method step 14 includes removing more than one water insoluble substance from the fruit. Even if more than one water insoluble substance is extracted, it should be understood that an exemplary second method step 14 includes removing only a portion of each one water insoluble substance from the fruit; for example, the portion of each one water insoluble substance being less than 90% removed (and includes less than 89% removed, and less than 88% removed, and less than any increment of 1% removed down to zero). Alternatively, if more than one water insoluble substance is extracted, it should be understood that the second method step 14 includes removing substantially an entirety of each one water insoluble substance from the fruit; for example, 90% and greater of each one of the water insoluble substances and includes a range of 90% to 97% removed. Further still, if more than one water insoluble substance is extracted, it should be understood that an exemplary second method step 14 includes removing substantially an entirety of only one (or more) water insoluble substance from the fruit as defined above while removing only a portion of only one (or more) of another one of the water insoluble substances from the fruit as defined above. That is, if more than one water insoluble substance is extracted, it should be understood that an exemplary second method step 14 includes removing any combination of: only a portion of any one of the water insoluble substances along with substantially an entirety of any one of the other water insoluble substances.

Still referring to FIG. 1, after performing the exemplary extraction method step 14 of the fruit processing method 10 according to various embodiments of the invention, a first fruit product remains from the originally-provided fruit. That is, a first fruit product is created or produced having a different structure and/or different composition from the fruit originally provided for the exemplary extraction method step 14. Furthermore, exemplary water soluble substances that are extracted in the inventive method include sugars. The exemplary extraction method step 14 includes removing a percentage or portion of any one or more sugars from the fruit and discussed more thoroughly subsequently.

Still referring to FIG. 1, an exemplary third method step 16 of the fruit processing method 10 includes providing the water soluble substance(s) extracted from the fruit to another station. At the another station, the water soluble substance(s) extracted can additionally be processed, discarded, or shipped directly to the market. Moreover, the another station can include an on-site station or an off-site station.

Still referring to FIG. 1, an exemplary fourth method step 18 of the fruit processing method 10 includes forming at least one infusion solution. Exemplary infusion solutions can be formed or produced either at an on-site station or at an off-site station. Still further, the fourth method step 18 can be performed at any stage of the method steps of fruit processing method 10. For example, the fourth method step 18 can be performed before the first method step 12 of the first processing method 10. Furthermore, the fourth method step 18 can be performed between the first method step 12 and the second method step 14 of the first processing method 10. Yet further, the fourth method step 18 can be performed between the second method step 14 and the third method 16 of the first processing method 10.

One exemplary fourth method step 18 of the fruit processing method 10 includes forming at least one infusion solution having at least a portion of at least one polyol. Exemplary polyols according to embodiments of the invention include: erythritol, isomalt, lactitol, maltitol, mannitol, polyglycitol, sorbitol and/or xylitol. A more thorough description of exemplary methods and ingredients thereof to create the infusion solution(s) for the fourth method step 18 according to various embodiments of the invention is described subsequently.

Still referring to FIG. 1, an exemplary fifth method step 20 of the fruit processing method 10 according to the invention includes infusing the first fruit product produced from the extraction method step 14 with one or more exemplary infusion solutions, for example, at least one of the infusion solutions prepared in the fourth method step 18. Performing the inventive fifth method step 20 creates or forms a second fruit product. The exemplary second fruit product will contain the infusion solution(s) and be devoid of the water soluble substance(s) (and any water insoluble substance(s)) extracted in the exemplary second method step 14. A more thorough description of an exemplary method and apparatus to infuse the infusion solution(s) into the first fruit product for the fifth method step 20 according to various embodiments of the invention is described subsequently. It should be understood that the exemplary second fruit product can be provided for further processing and/or provided to a market as is.

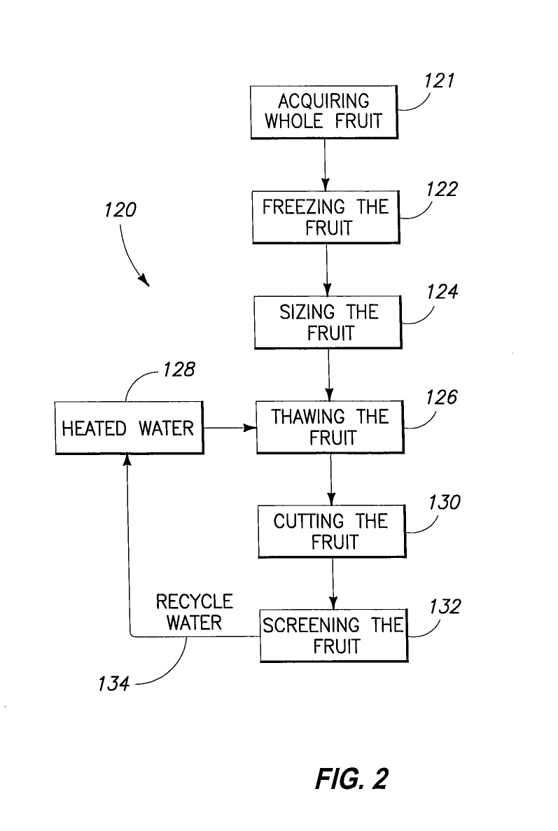

Referring to FIG. 2, an exemplary method 120 of providing the fruit, representing exemplary details of the first method step 12 for the fruit processing method 10, is described according to one of various embodiments of the invention. It should be understood that the exemplary method 120 of providing the fruit may, or may not, include various preparation methods steps for the fruit which may not be disclosed. An exemplary first method step 121 includes acquiring whole fruit by, for example, harvesting. Cranberries can be harvested from the Graylands region/area of the Washington coast. An exemplary sugar content of harvested fruit such as cranberries ranges from about 7 to about 8.5° brix with an average sugar content of about 7.5° brix. Other exemplary sugar contents exist for other fruits and the inventive methods disclosed herein are applicable to the other fruits and any sugar content. It should be understood that the exemplary first method step 121 includes providing the fruit in a dry state wherein drying the fruit after harvesting may be included.

Still referring to FIG. 2, an exemplary second method step 122 for the exemplary method 120 of providing the fruit includes freezing the fruit for storage. One purpose for freezing includes resolving the problem that lengthy time intervals between harvesting and processing can have on the desirability of fruit. Still another purpose for freezing the fruit is that it can facilitate subsequent processing of the fruit such as sizing the fruit. For other exemplary embodiments of the invention, the fruit is not frozen before being introduced to the method steps described subsequently.

Still referring to FIG. 2, an exemplary third method step 124 for the exemplary method 120 of providing the fruit includes removing the frozen fruit from storage and sizing the fruit. In an exemplary embodiment, the sizing is performed while the fruit is frozen which facilitates the sizing step without detrimentally affecting the fruit structure. Still further, sizing of the fruit exposes internal structures of the fruit allowing the release of gases (for example, air) which may be desirable, and ultimately, facilitates the extraction of water soluble substance(s) from the fruit in subsequent processing steps (such as the exemplary second method step 14 of the fruit processing method 10 previously described). In one exemplary embodiment of the invention, the fruit is sized through a series of screens.

It should be understood that various embodiments of the invention wherein the exemplary fruits are not presented in a whole state, the fruit can be provided in a state comprising any percentage of the whole, for example, such as halves. Furthermore, portions of the outer surface or skins of the fruit can be nicked to remove portions of the outer structure to improve or facilitate movement of water soluble and insoluble substances out of, and into, the fruit. The nicking procedure can be performed to an exemplary whole fruit only, or performed to a fruit in less than the whole state such as one having been previously sized, and for some embodiments of the invention, nicking would negate the need to size the fruit.

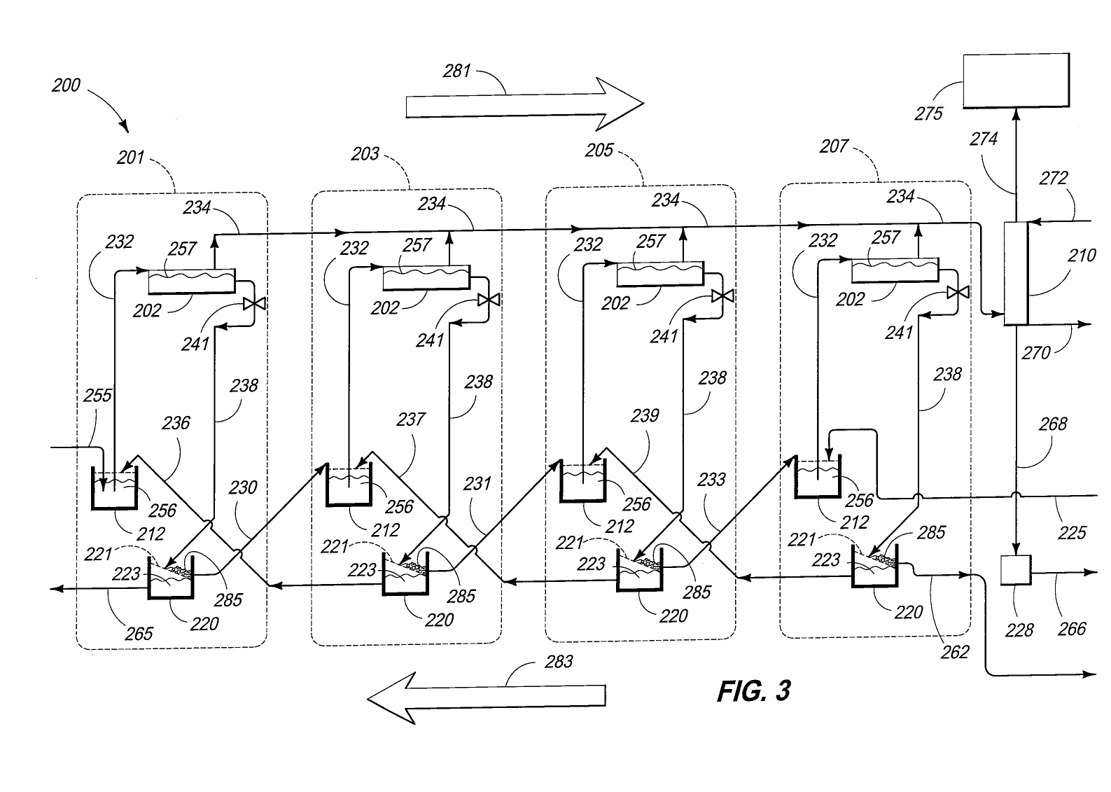

Still referring to FIG. 2, an exemplary fourth method step 126 for the exemplary method 120 of providing the fruit includes thawing the fruit. An exemplary thawing of the fruit includes transporting the sized fruit through a flume with heated water 128 to at least partially thaw the fruit. This partial thawing step 126 facilitates subsequent method steps for additional processing of the fruit. It should be understood that this method step 126 is optional and can be omitted wherein the fruit is provided frozen (not thawed) to the next method step 130. Still further, it should be understood that this method step 126 is optional and can be omitted wherein the fruit is provided frozen (not thawed) to an exemplary inventive extraction systems such as one disclosed in FIG. 3 below for the implementation of an extraction method step.

Still referring to FIG. 2, an exemplary fifth method step 130 of method 120 includes, optionally, an additional cutting of the fruit. However, this fifth method step 130 may be rendered unnecessary due to the previous third method step 124 of sizing the fruit. The optional fifth method step 130 can include nicking through the skin of the fruit (whether previous nicking performed or not). That is, this optional fifth method step 130 can include cutting the fruit without the nicking, or nicking the fruit without the cutting, and finally, a combination of cutting and nicking the fruit.

Still referring to FIG. 2, an exemplary sixth method step 132 for the exemplary method 120 of providing the fruit includes screening the fruit to remove the fruit from the heated water 128. It should be understood that the heated water 128 can be recycled 134 for reuse, for example, for additional or subsequent thawing in subsequent method steps. Alternatively, the thermal energy of the heated water 128 can be removed and stored for future use, and the water discarded. Still further, the heated water 128 can be discarded without removing the thermal energy.

Referring back to FIG. 1, exemplary inventive extractor devices and/or inventor extraction systems to implement the extraction method step 14 of the fruit processing method 10 are now described according to various embodiments of the invention (However, it should be understood that present extraction systems could be used, for example, a countercurrent extractor device as disclosed in U.S. patent to Fletcher (U.S. Pat. No. 5,747,088), the entire disclosure of which is incorporated herein).

An exemplary extraction system according to one of various embodiments of the invention is illustrated in FIG. 3 as extraction system 200. Extraction system 200 is more energy efficient and includes quicker times for an extraction method-step time (which increases the energy efficiency) during the extraction method step than prior art extraction systems. For example, an aspect of the extraction system 200 includes a extraction method step that includes a continuous and constant extraction influence on the berries/fruit. In one exemplary embodiment of the invention, the extraction method step is provided by a continuous vacuum as the influence for extracting water soluble substances from the berries/fruit. In another exemplary embodiment of the invention, the extraction method step is provided by a vacuum of a constant value as the influence for extracting water soluble substances from the berries/fruit. Still another exemplary embodiment of the invention, the extraction method step is provided by a continuous vacuum of a constant value as the influence for extracting water soluble substances from the berries/fruit.

In contrast, some prior art extraction systems rely upon an intermittent extraction influence on the berries/fruit. That is, the prior art extraction systems alternately cease, and begin again, the extraction influence on the berries/fruit. This is inefficient, and logically, increases the time period for completing the extraction method step as opposed to the continuous extraction method step provided by the inventive extraction system 200. Alternatively, some prior art extraction systems rely upon an extraction influence on the berries/fruit that is not constant wherein the extraction influence cycles between a peak extraction influence and a lesser trough extraction influence. This too is inefficient, and logically, increases the time period for completing the extraction method step as opposed to the constant extraction method step provided by the inventive extraction system 200.

Still further, another advantage of the inventive extraction system 200 is that the entire operation can continually function, without interruption, when additional berries/fruit are to be provided to extraction system 200. In contrast, some prior art extraction systems, such as batch systems, require a set quantity (up to a maximum amount), or batch, of berries/fruit provided in the prior art system and then that set quantity is processed to completion before another batch of fruit is provided. That is, the process for batch systems are interrupted or shut down until another batch of berries/fruit is added to the batch system before the entire process can begin again. This is inefficient, and logically, increases the time period for completing the entire extraction process as opposed to the continuous extraction process provided by the inventive extraction system 200. Consequently, as opposed to prior art extraction systems, the inventive extraction system 200 requires no downtime during any of the processing steps which increases efficiency and functionality while diminishing processing times and costs.

Still referring to FIG. 3, the exemplary extraction system 200 extracts various components from the fruit. In this exemplary embodiment, discussion is directed to the extraction system 200 being illustrated to extract or remove at least one or more water soluble substances from the fruit wherein the exemplary fruit is cranberries. The exemplary extraction system 200 shown includes one or more extractor cells (or barometric legs) (201, 203, 205 and 207 for purpose of this example only). Exemplary extraction systems 200 include extractor cells at opposite ends, and other exemplary extraction systems 200 have one or more extractor cells in between the extractor cells at opposite ends. Exemplary extraction systems 200 can have any number of extractor cells, including one extractor cell, two, three, four, five, six, seven, eight, nine, ten, eleven, twelve, thirteen, fourteen or more extractor cells. The more extractor cells, the more water soluble substance(s), such as sugars, that are removed from the fruit as the fruit moves through the extraction system 200.

In one of various exemplary embodiments of the extraction system 200 having two or more extractor cells located between the extractor cells at opposite ends, the in-between extractor cells may, or may not, be similarly configured and designed. Additionally, various exemplary embodiments of the extraction system 200 include one or both of the two extractor cells at opposite ends as being differently configured and designed relative to the one or more extractor cells in between the two extractor cells at opposite ends. In one of various exemplary embodiments of the extraction system 200, the two extractor cells at opposite ends may, or may not, be differently configured and designed relative to each other.

In the exemplary embodiment shown in FIG. 3, the exemplary extraction system 200 includes a series of four extractor cells 201, 203, 205, 207. The two in-between extractor cells 203 and 205 are similarly configured and designed. All four exemplary extractor cells 201, 203, 205, 207 include a distributor container 220 (or first container), a blending container 212 (or second container), and an extractor container 202 (or third container). In one exemplary embodiment of extraction system 200, each extractor container 202 is positioned elevationally above respective blending containers 212 and distributor containers 220.

Still referring to FIG. 3, each blending container 212 of extraction system 200 is in fluid communication with the extractor container 202 of the same extractor cell via respective conduits 232. Furthermore, an exemplary blending container 212 would be sized to hold approximately a range of from about 5 minute volume of product to about 20 minute volume of product, with a specific example being capable of holding about 20 minute volume of product. Moreover, blending container 212 of cell 201 receives an outlet of a solids conduit 255 which extends outside the extraction system 200 to establish fluid communication outside of the extraction system 200. Furthermore, blending container 212 of cell 201 is in fluid communication with the distributor container 220 of adjacent cell 203 via conduit 236. Blending container 212 of cell 203 is in fluid communication with the distributor container 220 of adjacent cell 205 via conduit 237. Blending container 212 of cell 205 is in fluid communication with the distributor container 220 of adjacent cell 207 via conduit 239.

Still referring to FIG. 3, blending container 212 of cell 201 receives fresh product in, such as fruit, and particularly fruit solids 256, through solids conduit 255. In one exemplary embodiment of the invention, exemplary fruit solids 256 are as described previously and throughout this document and can be prepared as described with respect to exemplary method 120 of providing the fruit as shown in FIG. 2. In other embodiments of the invention, conduits can be provided to present fruit solids to any one, or any combination of, blending containers 212 of cells 201, 203, 205 and 207. Furthermore, when more than one blending container 212 includes a conduit such as solids conduit 255 to receive fresh product such as fruit, the fruit can be provided to only one blending container at a time or any combination of the blending containers that have the conduit such as solids conduit 255.

Still referring to FIG. 3, blending container 212 of cell 207 receives a fluid such as a liquid, for example water, via conduit 225. In other embodiments of the invention, conduits can be provided to present a liquid such as water to any one, or any combination of, blending containers 212 of cells 201, 203, 205 and 207. Furthermore, when more than one blending container 212 includes a conduit such as conduit 225 to receive water, the water can be provided to only one blending container at a time or any combination of the blending containers that have the conduit such as conduit 225.

Still referring to FIG. 3, each distributor container 220 of extraction system 200 is in fluid communication with the extractor container 202 of the same extractor cell via respective conduits 238. Each conduit 238 has a valve 241 to control the flow of material through respective conduits 238. Moreover, each distributor container 220 has a perforated membrane 221, such as a screen, to separate solid material from fluid material. For one embodiment, the screen 221 is angled relative to a horizontal orientation. For another embodiment, the screen 221 is oriented to be substantially horizontal. Furthermore, distributor container 220 of cell 201 is in fluid communication with blending container 212 of adjacent cell 203 via conduit 230. Distributor container 220 of cell 203 is in fluid communication with blending container 212 of adjacent cell 205 via conduit 231. Distributor container 220 of cell 205 is in fluid communication with blending container 212 of adjacent cell 207 via conduit 233.

Still referring to FIG. 3, the distributor container 220 of cell 207 includes a conduit 262 which exits the extraction system 200 to allow a final product to exit the extraction system 200 from the distributor container 220 of cell 207. An exemplary final product is a fruit product described previously and throughout this document. Such fruit product is the water insoluble substance remaining after the extraction process provided by extraction system 200 to the original fruit provided through the solids conduit 255 to blending container 212 of cell 201. Still further, the fruit product is ready for further processing such as the exemplary fifth method step 20 of the fruit processing method 10 which includes infusing the fruit product described previously and throughout this document.

It should be understood that each distributor container 220 of the various cells can include a conduit such as conduit 262 of cell 207 which exits the extraction system 200 to allow a final product to exit the extraction system 200 from other distributor containers. In this configuration, each cell would provide a final product that has a different composition (i.e., different combinations of water soluble and insoluble substances) relative another cell in the extraction system 200.

Still referring to FIG. 3, it should be understood that respective conduits 230, 231 and 233 are configured to transport solids, fruit solids, from respective distributor containers 220 to respective blending containers 212 of adjacent cells. Consequently, exemplary embodiments of the respective conduits 230, 231 and 233 may include conveyors, respectively, such as screw conveyors. Alternative embodiments of the respective conduits 230, 231 and 233 may include perforated screw conveyors. Still further, various other embodiments of the inventions for the respective conduits 230, 231 and 233 would include vibrating troughs instead of, or in addition to, conveyors. The purpose of the vibrating troughs and conveyors is to move fruit solids to adjacent blending containers 212 while allowing fruit fluids to flow, under influence of gravity, back into respective distributor containers 220.

Still referring to FIG. 3, the exemplary distributor container 220 of cell 201 receives an inlet of juice conduit 265 which extends outside extraction system 200 to provide fluid communication outside extraction system 200. Distributor container 220 of cell 201 will release fluids therein, such as fruit fluids 223, through juice conduit 265 to outside the extraction system 200 for further processing or discarding. In one exemplary embodiment of the invention, fruit fluids 223 will be the water soluble substance(s), such as sugars, extracted from the original fruit described in the extraction method step 14 of the fruit processing method 10 of FIG. 1. The extracted water soluble substance(s) can be provided to another station as described in the third method step 16 of the fruit processing method 10 of FIG. 1.

It should be understood that each distributor container 220 of the various cells can include a conduit such as juice conduit 265 of cell 201 which extends outside extraction system 200 to provide fluid communication outside extraction system 200. Each distributor containers 220 of the various cell would then be capable of releasing fluids therein, such as fruit fluids 223, through respective juice conduits to outside the extraction system 200 for further processing or discarding. In this configuration, each cell could provide fluids having differing water soluble substance(s), such as sugars, extracted from the original fruit. It should be further understood that the fruit fluids (water soluble substances) 223 will comprise at least the sugars desired to be removed from the fruit and discussed more thoroughly subsequently. Still further, an exemplary another station as described in the third method step 16 of the fruit processing method 10 would include a concentration system or station to produce juice concentrate from the fruit fluids 223.

Still referring to FIG. 3, each extractor container 202 of each cell of extraction system 200 is in fluid communication with a vacuum source or system (or vacuum pump) 275 via a conduit 234 extending to a condenser 210. Condenser 210 is in fluid communication with the vacuum pump 275 via conduit 274. During operation of exemplary extraction system 200, each extractor container 202 is under the influence of a vacuum. The vacuum will effectively provide a pulling action on the fruit provided therein to pull fruit fluids (water soluble substances such as sugars) from the fruit solids (water insoluble substances). Accordingly, a mixture 257 of fruit solids and fruit fluids will reside in extractor containers 202. Gas and vapor from the mixture will be removed through conduit 234 to condenser 210 wherein some (discussed below) of the gas and vapor are condensed into condensate or condensation fluid to move through conduit 268 to collection tank 228. Condensation fluid can be moved from collection tank 228 to exit extraction system 200 via conduit 266 and processed further or discarded. It should be understood that a cold fluid, such as water, brine or glycol, enters condenser 210 via conduit 272 to allow condenser 210 to operate and exits condenser 210 via conduit 270.

Still referring to FIG. 3, it should be understood that fruit solids move generally in direction 281 through extraction system 200 to ultimately exit extraction system 200 through conduit 262 as fruit products previously described. Furthermore, it should be understood that fruit fluids move generally in direction 283 through extraction system 200 to ultimately exit extraction system 200 through juice conduit 265 as sugar solutions (previously described water soluble substance(s)).

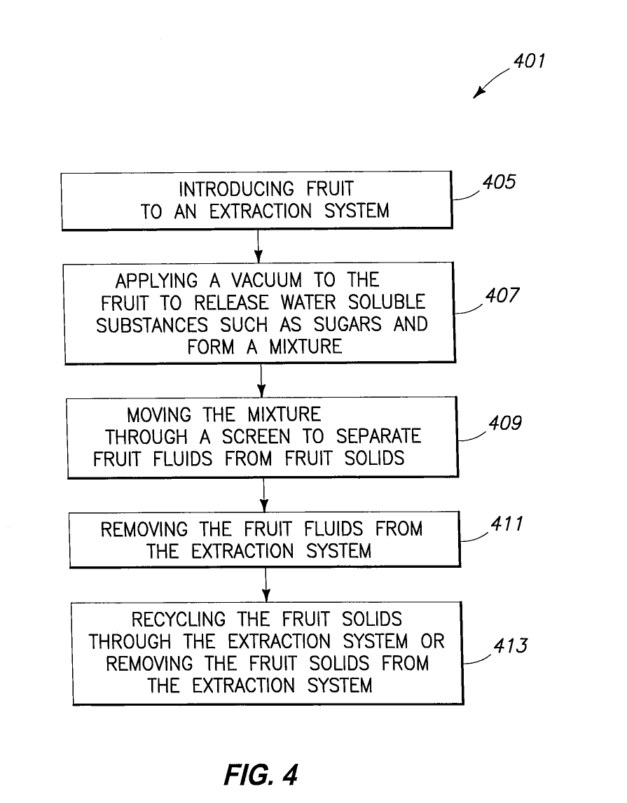

Referring to FIG. 4, an exemplary extraction method 401 using extraction system 200 of FIG. 3 is described according to one of various embodiments of the invention. Exemplary preliminary method steps include providing the extraction system 200; closing valves 241 of the various cells; activating the vacuum pump 275 to establish a vacuum through conduit 234 to respective extractor containers 202; and activating the condenser 210 by allowing a cold fluid to enter condenser 210 via conduit 272 and exit condenser 210 via conduit 270. Another exemplary preliminary method step includes introducing a fluid such as a liquid, for example water, to the extraction system 200. The introduction of fluid should be at least to blending container 212 of cell 207 via conduit 225.

It should be understood that the introduction of fluid can be to any one, or any combination of, respective blending containers of the various cells including container 212 of cell 201. It should be further understood that any of these preliminary method steps can be omitted if the structures are already in a desired state or condition. Moreover, it should be understood that the preliminary method steps can be performed in any combination and in any order of steps.

Referring to FIGS. 3 and 4, an exemplary first method step 405 for the exemplary extraction method 401 includes introducing fruit (or fruit/berry) to the extraction system 200. For example, introducing the fruit/berry to the blending container 212 (first container) of cell 201 via solids conduit 255. Additionally, the introduction can be to any one, or combination, of respective blending containers of the various cells, either generally at the same time or in different time stages. It should be understood that fruit in blending container 212 may include fruit solids, and further during subsequent processing, may include fruit fluids and fruit liquids (in one embodiment of the invention, sugars) provided via conduit 236 from adjacent cell operation such as cell 203. The other blending containers 212 of respective cells may also have the combination of fruit solids and liquids but in different respective percentages. Accordingly, the contents of respective blending containers 212 will be referred to as mixture 256.

It should be understood that the following discussion of method steps will be addressing method steps for only one cell 201 with the understanding that the other cells will function/operate similarly (with the understanding that end cells on opposite ends will have a few unique method steps addressed subsequently). An exemplary next method step for extraction method 401 includes moving mixture 256 from blending container 212 through conduit 232 to the extractor container 202 (second container) which is elevationally above blending container 212. It should be understood that mixture 256 will substantially include only the fruit in the beginning of the extraction method 401. Before the next method step, it should be understood that valve 241 is closed if not already performed, and a vacuum is applied to extractor container 202 via vacuum pump 275 if not already performed.

Still referring to FIGS. 3-4, an exemplary second method step 407 for the exemplary extraction method 401 includes allowing or applying the vacuum upon the fruit (and/or mixture 256) in the extractor container 202 for a period of time to convert or transform the mixture 256 into another mixture 257. That is, the vacuum effectively applies a pulling action on the fruit to release/separate fruit fluids (the water soluble substances discussed previously), vapors and gases from fruit solids (the water insoluble substances discussed previously). The exemplary fruit fluids released include sugars. Exemplary periods of time for allowing the vacuum to act on the mixture 257 include a range of from about 10 seconds to about 7 (seven) minutes, and any length of time in between having incremental differences of one second. Another exemplary range for a period of time for allowing the vacuum to occur is about 1 minute to about 5 minutes.

For each exemplary period of time for the vacuum discussed herein, the vacuum will be provided continuously and with a constant value according to one embodiment of the invention. An exemplary range of vacuum values according to various embodiments of the invention for the exemplary periods of time for the vacuum discussed herein include about 3 p.s.i. (lb./in.²) to about 14 p.s.i., and including any one-tenth ( 1/10) of a p.s.i. in between the listed range of vacuum values. One exemplary vacuum value is 10 p.s.i. Still other exemplary embodiments of the invention include the vacuum not being provided in a continuous state and not being provided as a constant value.

The vapors released from mixture 257 travel through conduit 234 to condenser 210. Some vapors, such as oxygen, will remain as a vapor or gas under the influence of condenser 210 and ultimately escape or exit system 200 through the vacuum pump 275. However, other vapors will be condensed under the influence of condenser 210 to form at least a liquid which flows into collection tank 228 via conduit 268 and eventually removed from collection tank 228 through conduit 266 and processed further or discarded as discussed previously.

After the vacuum is allowed to act on the mixture 257 for the predetermined period of time, an exemplary another method step of extraction method 401 includes opening valve 241 and allowing mixture 257 to flow from extractor container 202 through conduit 238 to distributor container 220 (a third container). In one exemplary embodiment of the invention, the mixture 257 flows through conduit 238 to distributor container 220 under the influence of at least gravity. In still another embodiment of the invention, and the mixture 257 flows through conduit 238 to distributor container 220 under the influence of gravity and the vacuum still being applied to extractor container 202.

Still referring to FIGS. 3 and 4, an exemplary third method step 409 for the exemplary extraction method 401 includes moving mixture 257 through screen 221 and separating mixture 257 into fruit fluids (liquid portions) (water soluble substances) 223 and fruit solids (solid portions) (water insoluble substances) 285. The fruit fluids 223 will pass through screen 221 into a lower portion of distributor container 220. The fruit solids 285 will reside on top of screen 221 and can be referred to as a first fruit product.

Still referring to FIGS. 3 and 4, an exemplary fourth method step 411 for the exemplary extraction method 401 includes drawing off the fruit fluids 223 from distributor container 220 to exit the extraction system 200 via juice conduit 265.

Alternatively, if the extraction method is being performed in another cell, such as to the right in this view (that is, a cell other than cell 201), fruit fluids 223 will be drawn off from distributor container 220 from the another cell and moved to the blending container 212 of the cell to the left in this view. For example, fruit fluids 223 are drawn off from distributor container 220 of cell 205 and moved to the blending container 212 of cell 203 via conduit 237.

Still referring to FIGS. 3 and 4, an exemplary fifth method step 413 for the exemplary extraction method 401 includes recycling fruit solids 285 through the extraction system 200. An exemplary recycling method step 413 includes transporting the fruit solids 285 to blending container 212 of cell 203 via conduit 230 which has the previously-described conveyor and/or vibrating trough. The fruit solids 285 transported to blending container 212 of cell 203 will be cycled through cell 203 for processing similar to the processing through cell 201 just described. It should be understood that each container in cell 203 (and any other cell of extraction system 200) will have fruit solids and fruit fluids with different fruit compositions from one cell to the next cell even though the different fruit compositions are represented with the same reference number from one cell to the next cell for ease of understanding.

Alternatively, an exemplary fifth method step 413 for the exemplary extraction method 401 will include drawing off the fruit solids 285 from distributor container 220 to exit the extraction system 200, for example, as shown from cell 207 via conduit 262. In this alternative method step, the fruit solids as the first fruit product will exit the extraction system 200 representing a final product for further processing discussed throughout this document (or to be sold as is). Such further processing includes the method step 20 of the fruit processing method 10 of infusing the fruit product as described previously. Moreover, it should be understood that the fruit solids 285 are the water insoluble substance(s) of the original fruit provided to the extraction method 401. Each processing through a cell of extraction system 200 produces a different fruit product more devoid of water soluble substance(s) (fruit fluids). Accordingly, the cycling and recycling processing of fruit solids and fruit fluids through respective cells generally has the same journey and processing except for when the fruit solids and fruit fluids are selected to exit the extraction system 200.

It should be understood that at the beginning of the extraction processing and relying upon the extraction method 401 (of FIG. 4) using the extraction system 200 (of FIG. 3), the fruit and/or berries provided will have approximately 8% to about 20% water soluble substances by weight/volume (also abbreviated as wt./vol.). Furthermore, upon completion of the extraction method 401, the final fruit product exiting the extraction system 200 has about 1% to about 10% water soluble substances by weight/volume. Stated another way, approximately 50-85% weight/volume of the water soluble substances in the original fruit/berry are removed during the extraction method 401. Exemplary water soluble substances removed include sugars and acids. For some embodiments of the invention, the water soluble substances removed include flavor components in addition to sugars and acids.

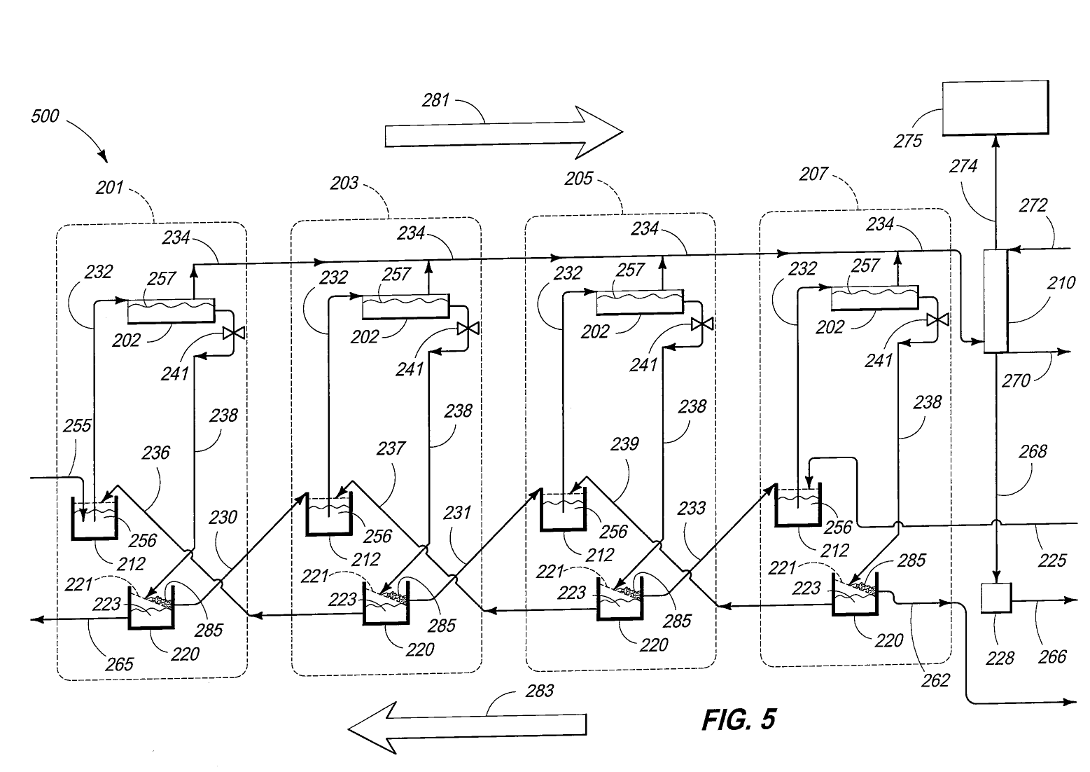

The final fruit product produced by the inventive extraction method 401 of FIG. 4 through the inventive extraction system 400 of FIG. 3 is ready for further processing such as being infused with an infusion solution as described in the exemplary fifth method step 20 of the fruit processing method 10 of FIG. 1. An exemplary infusion system 500 for performing the infusion method step 20 is described with respect to FIG. 5. Exemplary infusion solutions, and methods for producing or forming the exemplary infusion solutions, are described subsequently.

Referring to FIG. 5, an exemplary infusion system 500 is illustrated and described according to one of various embodiments of the invention. The exemplary infusion system 500 is designed and configured the same as the previously-described extraction system 200, and therefore, includes the same reference numbers for structures as previously presented with regard to extraction system 200. Moreover, the method of operating the infusion system 500 is the same as previously described for operating the extraction system 200 except for two main method step distinctions. Other than these two method step distinctions (discussed below), the previous discussions and descriptions with regard to the methods of using the extraction system 200 are applicable to the following discussions and descriptions of methods for using the infusion system 500. Furthermore, the following discussion is directed only to the method step distinctions of using infusion system 500 which are in contrast to using the extraction system 200.

Referring to FIG. 5, an exemplary first method step distinction of using infusion system 500 is described. It should be understood that a first fruit product (or final fruit product) has already been produced, and in one exemplary embodiment of the invention, has been produced by the inventive extraction method 401 utilizing the inventive extraction system 200. The exemplary first method step distinction (of using infusion system 500 in contrast to using the extraction system 200) includes providing the first fruit product to the blending container 212 of cell 201 via solids conduit 255 in contrast to providing the original fruit to cell 201 with respect to the extraction method 401. The first fruit product is processed through cell 201 using infusion system 500 as previously described with respect to the extraction method 401. Moreover, the first fruit product is cycled and processed through cells 203, 205 and 207 of infusion system 500 same as previously described for the original fruit in the extraction method 401.

Still referring to FIG. 5, an exemplary second method step distinction of using infusion system 500 is described. It should be understood that an infusion solution has already been produced, and in one exemplary embodiment of the invention, has been produced by exemplary inventive methods discussed subsequently. The exemplary second method step distinction (of using infusion system 500 in contrast to using the extraction system 200) includes providing an infusion solution (or infusion syrup) to blending container 212 of cell 207 via conduit 225 in contrast to providing water to cell 207 with respect to the extraction method 401. An exemplary infusion solution according to one embodiment of the invention includes at least one or more sugars, for example, a 60-70° brix sugar solution. For another embodiment of the invention, an exemplary infusion solution includes at least one or more polyols to form an inventive polyol solution described subsequently.

Still referring to FIG. 5, the first fruit product moves generally in direction 281 to cycle through the infusion system 500 and the polyol solution moves generally in the opposite direction 283 to cycle through the infusion system 500. Cycling of the first fruit product and polyol solution through the infusion system 500 creates a new second fruit product wherein the polyol solution is infused into the first fruit product. That is, the polyol solution permeates into the first fruit product wherein the second fruit product has a polyol concentration. The exemplary second fruit product ultimately exits infusion system 500 from cell 207 through conduit 262 as a fruit product to be sold or further processed. The polyol solution ultimately exits infusion system 500 from cell 201 through juice conduit 265 being diluted to a 30-50° brix solution from the original 60-75° brix solution.

It should be understood that the inventive extraction system 200 and inventive infusion system 500 having cells configured in a series produces the effect of an exemplary counter-current extraction or infusion, respectively.

Inventive infusion solutions and exemplary methods of forming inventive infusion solutions are now described according to various embodiments of the invention. The inventive methods and systems described previously can be used in combination with the inventive infusion solutions to form inventive fruit products including dehydrated fruit products. For example, the inventive infusion solutions described below can be formed and provided in the exemplary fourth method step 18 of the fruit processing method 10 of FIG. 1.

One exemplary infusion solution according to an embodiment of the invention will be termed Blend #1 for ease of discussion. Blend #1 is a combination of Solutions “A” and “B” wherein each of Solutions “A” and “B” can be purchased from Roquette America, Inc. In one embodiment of the invention, equal volumes of each of Solution A and Solution B are mixed together to produce Blend #1, that is, a Solution 50-50 (vol.vol.). However, it should be understood that Solution A alone is another exemplary infusion solution according to an embodiment of the invention and that Solution B alone is another exemplary infusion solution according to an embodiment of the invention.

Preparation of Blend #1 is a 50-50 volume-volume solution of Solution A and Solution B:
1) Solution A is named Polysorb® FM 75/4/67 (exp) Lab #9238 75° brix by Roquette America, Inc. and includes:
   Maltitol/hydrogenated Starch hydrolysates composition
   D-maltitol 65.0% min
   D-sorbitol 6.0% max
   Reducing sugars 0.3% max
   Soluble Fiber 10% min
2) Solution B is named Maltitol Syrup Lab #9145 75° apparent brix by Roquette America, Inc. and includes:
   D-maltitol 50.0% min
   D-sorbitol 25% max
   Reducing sugars 0.3% max.

Another exemplary infusion solution according to an embodiment of the invention will be termed Blend #2 for ease of discussion. Blend #2 is a Solution 60° brix Fructose with citric acid. Preparation of Blend #2 includes 50% (wt./vol.) Fructose with 0.1% (wt./vol.) citric acid added.

Yet another exemplary infusion solution according to an embodiment of the invention will be termed Blend #3 for ease of discussion. Blend #3 is a Solution 50-50 Roquette with Fructose and citric acid added. Preparation of Blend #3 includes an equal volume of Blend #1 (see above) mixed with an equal volume of Blend #2 (see above). The final combination or blend measured 72° brix.

Exemplary infusion methods using these inventive infusion solutions according to various embodiments of the invention will be discussed. However, first an overview of the original fruit preparation is discussed along with the state of the original fruit as it exists after an extraction method is performed on the original fruit.

An exemplary original fruit includes cranberries. Whole frozen cranberries can be acquired from the Graylands area of the Washington state coast. Exemplary sugar content of the cranberries ranged from approximately 7-8.5° brix. The cranberries are provided in large plastic bags in a dry and free moving state similar to individually quick frozen (I.Q.F.) fruit. The cranberries are removed from the bags in the frozen state, sized and sorted. The cranberries are sliced in halves for the processing.

An extraction method using an extraction system (both previously described) according to one of various embodiments of the invention is described. The exemplary extraction method is used to extract juice which as previously described may include removing water soluble and/or water insoluble substances from the originally-provided fruit. In one exemplary embodiment, the extraction method removes approximately one half (½) of the juice from the cranberries. In this state, the cranberries have approximately half of the initial sugar content. That is, the original sugar content of the cranberries is reduced to a sugar content ranging from approximately 3-5° brix. The juice removed from the cranberries can be further processed, for example, provided in a concentrated state and used for other products such as juice blends.

The extraction method produces a first fruit product. Characteristics of the first fruit product according to one embodiment of the invention are described. Carbohydrates are the primary water soluble solids (or substances) found in fruits. Consequently, the inventive infusion solutions enhance or replace the soluble solids (carbohydrates) in the originally-provided fruit which have been removed by the extraction methods. Exemplary replacement ingredients provided by the inventive infusion solutions include carbohydrate materials of appropriate size and characteristics and will impart texture, body, density, appearance, flavors and/or sweetness to the final fruit product. Another advantage of the infusion solutions is the reduction of calories to produce a reduced-sugar fruit product. The reduced-sugar fruit product can also be characterized as a reduced-calorie fruit product. The inventive infusion solutions include soluble solids having molecular sizes and shapes that is conducive to penetrate the subject fruit for optimum fruit enhancement.

Still referring to carbohydrates, this term applies to a large group of organic compounds. These organic compounds are monomeric, oligomeric and polymeric in nature and do not necessarily have their hydrogen and oxygen atoms in a ratio of 2:1. Carbohydrates can be either synthesized from, or hydrolyzed to, monosaccharides and include, but are not limited to, sugar alcohols, monosaccharides, disaccharides, oligosaccharides and polysaccharides. Moreover, carbohydrates include digestible, partially digestible or non-digestible blends.

Other carbohydrate soluble solids that may be included in the inventive infusion solutions can be described as oligomers of DP polymers of 2-11 units. Non-limiting examples include:
1) Monosaccharides and sugar alcohols which include arabinose, xylose, ribose, psicose, sorbose, glucose, fructose, galactose, mannose, sorbitol, mannitol and maltitol;
2) Disaccharides which include sucrose, maltose and cellobiose;
3) i) Oligosaccharides which include fructo-oligosaccharides, maltotriose, raffinose, stachyose;
   ii) simple oligosaccharides which on depolymerization yield monosaccharides only; and
   iii) maltose oligomers such as corn syrup solids or partially hydrolyzed starch or partially hydrolyzed cellulose;
4) Conjugate oligosaccharides which on depolymerization yield monosaccharides and alycons; and
5) Polysaccharides which include a group that contains many useful examples from a wide range of products: legumes, cereals, seaweeds, types of starches, and other plant materials that might include soluble and insoluble fibers and other polysaccharides of interest.

After a cranberry is provided through the extraction method to produce the first fruit product, the first fruit product is drained. The inventive infusion solutions are produced (or already produced) and warmed. An infusion method using an infusion system (such as those previously described) is used to force the infusion solution into the first fruit product to produce a second fruit product. The second fruit product is dehydrated to about 18% optimum moisture. Optionally, glycerol is added to keep the respective pieces of the second fruit product from sticking together. The final fruit products are customized fruit products which enhance the originally-provided fruit with improved shape, texture, density, appearance and flavor.

It should be understood that the inventive infusion solutions discussed above can be used in conjunction with other sweeteners to create synergistic effects. The infusion solutions are effective sugar substitutes in many applications because they exhibit similar physical properties to traditional sugars. Polyols are different in chemical structures from traditional sugars but they have enough of the structure to keep many of the physical properties of the sugars. Polyols are converted to contain functional hydroxyl groups. Many polyols are produced commercially from starch hydrolysates. Since polyols are metabolized differently than the traditional sugars and carbohydrates, and they are known to lower blood glucose levels, they are useful for diabetics. Accordingly, the infusion solutions having polyols are important as sweeteners and are formulated to create a fruit product that has reduced calories, good flavor, sweetness and increased fiber.

It should be understood that the final fruit product results from fruit that has been infused with the inventive infusion solutions which include various combinations of digestible, partially digestible or non-digestible carbohydrates. Furthermore, additional ingredients can be optionally provided in the infusion solutions to enhance sensory characteristics and product quality attributes and can include, but are not limited to, colors, flavors and acidulants. These custom-enhanced final fruit products may be presented as fresh fruit products or as a dehydrated fruit product.

Additional details for the preparation of cranberries are described according to one of various embodiments of the invention. 400 grams of frozen cranberries were prepared generally as described previously. The cranberries are placed in an open container and 400 grams of water is mixed with the berries (hereinafter referred to as mixture). The mixture is heated using a microwave oven or conventional means to 102° F. Other exemplary temperatures for the mixture include a range of approximately 90-114° F. The mixture is provided in an extraction method.

One exemplary extraction method according to the invention includes the following exemplary parameters for the mixture:
Method step 1) mixture (cranberries and water) are pulsed in a vacuum system;
Method step 2) vacuum cycled four times at 15 inches Hg.;
Method step 3) duration for each vacuum cycles lasts approximately three minutes; and
Method step 4) atmospheric pressure when the vacuum cycle is off is sea level pressure and the duration at the atmospheric pressure lasts approximately three minutes.
   Results for the one exemplary extraction method are: initial cranberries equaled 7.5° brix; Cycle 1=2.0° brix (it should be understood that each brix value indicates the measured brix of the water (of the mixture) after each vacuum cycle; for example, at cycle 0 which is before the first vacuum cycle (Cycle 1), the water is 0 brix); Cycle 2=2.7° brix; Cycle 3=3.0° brix; and Cycle 4=3.2° brix. Accordingly, after Cycle 4, the berries have given up soluble components totaling 3.2 brix to the water. Stated another way, approximately 43% of the soluble components in the cranberries were removed to the water. Next, the extracted cranberries are drained and weighed. The drained weight equaled 407 grams with the solution having a temperature of approximately 100° F.

After the extraction method, an exemplary infusion method for the cranberries is described according to one of various embodiment of the invention. The exemplary infusion solution used for this infusion method is Blend #1 described previously:
Method step 1) 200 grams of prepared cranberries (partial juice extracted) are placed in an open container;
Method step 2) 200 grams of Blend #1 infusion solution (or syrup) is added to the cranberries (hereinafter referred to as mixture);
Method step 3) the mixture is heated in a microwave oven to approximately 110° F. Alternatively, conventional heating could be used as well;
Method step 4) the warm mixture is pulsed in a vacuum system under the following conditions: Vacuum=15 inches Hg.; Duration=4 cycles of three 3 minutes each with vacuum on; and Break vacuum=ambient air (general pressure-sea level) with 3 minutes of vacuum off for each cycle;
The resulting data for the exemplary infusion method includes: mixture temperature after infusion cycles=96° F.; brix value of mixture after infusion cycles=56° brix;
Method step 5) The reduced sugar cranberry pieces are then dehydrated in a laboratory dryer to a moisture content of approximately 18-20%; and
Method step 6) Less than 1% glycerol is sprayed onto the cranberry surfaces as an optional ingredient to increase the visual appeal (shine characteristic) and to prevent the sticking together of the fruit pieces.

Another exemplary infusion method is described according to another one of various embodiments of the invention. The exemplary infusion solution used for this infusion method is Blend #1. Moreover, the cranberries are presented for the infusion method without having been through an extraction method:
Method step 1) 200 grams of cranberries are provided in an open container;
Method step 2) 200 grams of Blend #1 infusion solution is added to the cranberries;
Method step 3) the mixture is heated in a microwave oven to approximately 114° F. Alternatively, conventional heating could be used as well;
Method step 4) the warm mixture is pulsed in a vacuum system under the following conditions: Vacuum=15 inches Hg.; Duration=4 cycles of three 3 minutes each with vacuum on; and Break vacuum=ambient air (general pressure-sea level) with 3 minutes of vacuum off for each cycle;
The resulting data for the exemplary infusion method includes: mixture temperature after infusion cycles=90° F.; brix value of mixture after infusion cycles=52° brix;
Method step 5) The reduced sugar cranberry pieces are then dehydrated in a laboratory dryer to a moisture content of approximately 18-20%; and
Method step 6) Less than 1% glycerol is sprayed onto the cranberry surfaces as an optional ingredient to increase the visual appeal (shine characteristic) and to prevent the sticking together of the fruit pieces.

Yet another exemplary infusion method is described according to another one of various embodiments of the invention. The exemplary infusion solution used for this infusion method is Blend #1. Moreover, the cranberries are presented for the infusion method without having been through an extraction method:
Method step 1) 200 grams of cranberries are provided in an open container;
Method step 2) 200 grams of Blend #1 infusion solution is added to the cranberries;
Method step 3) the mixture is heated in a microwave oven to approximately 86° F. Alternatively, conventional heating could be used as well;
Method step 4) the mixture is allowed to equalize under static conditions for 2.0 hours. The mixture is maintained at 86° F. during the static equalization;
Method step 5) the warm mixture is pulsed in a vacuum system under the following conditions: Vacuum=15 inches Hg.; Duration=4 cycles of three 3 minutes each with vacuum on; and Break vacuum=ambient air (general pressure-sea level) with 3 minutes of vacuum off for each cycle;
The resulting data for the exemplary infusion method includes: mixture temperature after infusion cycles=80° F.; brix value of mixture after infusion cycles=54° brix; and
Method step 6) The reduced sugar cranberry pieces are then dehydrated in a laboratory dryer to a moisture content of approximately 18-20%.

Still another exemplary infusion method for the cranberries is described according to one of various embodiment of the invention. The exemplary infusion solution used for this infusion method is Blend #3 and the cranberries have been through an extraction method:
Method step 1) 200 grams of prepared cranberries (partial juice extracted) are placed in an open container;
Method step 2) 200 grams of Blend #3 infusion solution (or syrup) is added to the cranberries (hereinafter referred to as mixture);
Method step 3) the mixture is heated in a microwave oven to approximately 114° F. Alternatively, conventional heating could be used as well;
Method step 4) the warm mixture is pulsed in a vacuum system under the following conditions: Vacuum=15 inches Hg.; Duration=4 cycles of three 3 minutes each with vacuum on; and Break vacuum=ambient air (general pressure-sea level) with 3 minutes of vacuum off for each cycle;
The resulting data for the exemplary infusion method includes: mixture temperature after infusion cycles=90° F.; brix value of mixture after infusion cycles=55° brix;
Method step 5) The reduced sugar cranberry pieces are then dehydrated in a laboratory dryer to a moisture content of approximately 18-20%; and
Method step 6) Less than 1% glycerol is sprayed onto the cranberry surfaces as an optional ingredient to increase the visual appeal (shine characteristic) and to prevent the sticking together of the fruit pieces.

These exemplary extraction methods and infusion methods produced uniquely different fruit products having reduced sugar. The differences will appeal to a particular customer desiring to modify their sugar intake. One exemplary embodiment of the invention is a fruit product characterized as an extracted fruit/berry. Another exemplary embodiment of the invention is a fruit product characterized as an infused fruit/berry. Still another exemplary embodiment of the invention is a fruit product characterized as an infused, dried fruit/berry. Yet another exemplary embodiment of the invention is a fruit product characterized as an infused fruit/berry with no sugar. And still another exemplary embodiment of the invention is a fruit product characterized as an infused, dried fruit/berry with no sugar. It should be understood that each final fruit product has a different flavor profile. In fact, the last infusion method described above (of the four) produces a final fruit product having the sweetest flavor due to the added fructose. Moreover, the final fruit products have high quality even after 6 months of shelf life testing.

In compliance with the statute, the invention has been described in language more or less specific as to structural and methodical features. It is to be understood, however, that the invention is not limited to the specific features shown and described, since the means herein disclosed comprise various forms of putting the invention into effect. The invention is, therefore, claimed in any of its forms or modifications within the proper scope of the appended claims appropriately interpreted in accordance with the doctrine of equivalents.

The invention claimed is:

1. A method for producing fruit products, the method comprising:
presenting a fruit comprising at least one water insoluble component and at least one water soluble component;
removing at least a portion of the at least one water soluble component from the fruit, the removing comprising leaving at least a portion of the at least one water insoluble component; and
providing at least one polyol in the at least a portion of the at least one water insoluble component.

2. The method of claim 1 wherein the providing comprises infusing the at least one polyol.

3. The method of claim 1 wherein the providing comprises providing at least two polyols.

4. The method of claim 1 wherein the providing comprises providing at least one polyol from the following list of polyols: erythritol, isomalt, lactitol, maltitol, mannitol, polyglycitol, sorbitol and xylitol.

5. The method of claim 1 wherein the removing comprises providing a vacuum on the fruit at a constant value.

6. The method of claim 1 wherein the removing comprises providing a continuous vacuum on the fruit.

7. The method of claim 1 wherein the fruit comprises at least one of cherries, strawberries, raspberries, blueberries and cranberries.

8. The method of claim 1 wherein the removing comprises providing a continuous vacuum on the fruit at a constant value.

9. A method for producing a fruit product comprising removing sugars from a fruit or berry.

10. The method of claim 9 wherein the fruit or berry comprises a cranberry.

11. The method of claim 9 further comprising providing at least one additive in the fruit or berry to enhance at least one of: sensory characteristics, quality attributes and beneficial attributes.

12. The method of claim 9 further comprising infusing the fruit or berry with a polyol.

13. A fruit product comprising:
a water insoluble component of a fruit; and
at least one polyol.

14. The fruit product of claim 13 wherein the at least one polyol comprises at least one of the following: erythritol, isomalt, lactitol, maltitol, mannitol, polyglycitol, sorbitol and xylitol.

15. The fruit product of claim 13 further comprising a sugar that was not originally in the fruit.

16. The fruit product of claim 13 further comprising a fruit acid that was not originally in the fruit.

17. The fruit product of claim 13 wherein the fruit comprises a berry.

18. The fruit product of claim 13 wherein the water insoluble component comprises an external cellular covering of a fruit.

19. A fruit extraction system comprising a plurality of cells, each cell comprising substantially the same configuration of containers in fluid communication.

20. The system of claim 19 further comprising a vacuum pump in fluid communication with the plurality of cells and configured to provide a vacuum on a fruit to extract at least one water soluble substance from the fruit.

21. A fruit infusion system comprising a plurality of cells, each cell comprising substantially the same configuration of containers in fluid communication.

22. The system of claim 21 further comprising a vacuum pump in fluid communication with the plurality of cells and configured to provide a continuous and constant vacuum.
